(19) United States
(12) Patent Application Publication
(10) Pub. No.: US 2023/0307911 A1
(43) Pub. Date: Sep. 28, 2023

(54) METHOD AND SYSTEM FOR OPTIMIZING POWER GRID EMERGENCY LOAD-SHEDDING BASED ON PROLIFERATION AND REDUCTION EVOLUTION

(71) Applicant: SHANDONG UNIVERSITY, Jinan (CN)

(72) Inventors: Changgang LI, Jinan (CN); Chenhao GAI, Jinan (CN); Taoyang XU, Jinan (CN); Yutian LIU, Jinan (CN)

(73) Assignee: SHANDONG UNIVERSITY, Jinan (CN)

(21) Appl. No.: 18/125,265

(22) Filed: Mar. 23, 2023

(30) Foreign Application Priority Data
Mar. 23, 2022 (CN) 2022102870032

(51) Int. Cl. H02J 3/14; G05B 19/042

(52) U.S. Cl. CPC H02J 3/14; G05B 19/042; G05B 2219/2639; H02J 2203/20

(57) ABSTRACT

A method and system for optimizing power grid emergency load-shedding based on proliferation and reduction evolution. The method includes the steps of obtaining upper and lower limits data of allowed load-shedding amount of each load and boundary threshold data of transient security and stability constraint indexes of a power grid; and obtaining an optimal power grid emergency load-shedding scheme based on these data and an evolutionary optimization method, wherein the key of the evolutionary optimization method to work is proliferation and reduction evolution strategies. The proliferation strategy with multiple evolution search operators is proposed to generate many temporary candidate schemes. The reduction strategy of temporary candidate schemes includes two key steps, that is, pre-screening of based on a surrogate model and validation based on time-domain simulation.

### TECHNICAL FIELD

The present disclosure relates to the technical field of emergency load-shedding control of power systems, and particularly relates to a method and system for optimizing power grid emergency load-shedding scheme based on proliferation and reduction evolution.

### BACKGROUND

This part only provides the background information related to the present disclosure, and does not necessarily constitute the prior art.

Renewable energy power generation is generally integrated into a power system through a power electronic converter, and centralized large-scale renewable energy power generation is generally subjected to transmission through a high voltage direct current technology. The integration of renewable energy power generation based on the converter and high voltage direct current transmission enables rich control flexibility of the power system, but also causes huge security risks, especially potential off-grid operation of renewable energy unit or direct current blocking. These disturbances may lead to a severe power imbalance phenomenon to the power system to influence the transient security and stability of the power system. In order to ensure the transient security and stability of the power system after disturbance, emergency load-shedding control is performed to actively shed a proper number of loads in a short time to balance power generation and consumption. However, the shed load will influence the life of users and may cause great social and economic losses. Therefore, minimizing the emergency load-shedding cost is always the target of optimizing an emergency load-shedding scheme while meeting the transient security and stability constraints of the system.

Emergency load-shedding optimization is a high-dimensional and constrained optimization problem with multiple local optima. Evolutionary algorithms, such as a genetic algorithm, a particle swarm optimization algorithm and a differential evolution algorithm, are independent of mathematical characteristics of the problem, and have robustness and wide applicability for different nonlinear optimization problems. Therefore, the evolutionary algorithms are widely and effectively applied to a nonlinear emergency load-shedding optimization problem.

In the evolutionary algorithms, it is needed to iteratively generate a large number of candidate schemes according to evolutionary logic to locate a global optimal scheme. The global convergence of the evolutionary algorithms is related to the diversity of the candidate schemes. A large candidate scheme population can effectively improve the global convergence of the evolutionary algorithms. However, the large candidate scheme population will significantly increase the calculation burden of optimization at the same time, and such calculation burden lies in evaluating each candidate scheme by computational-intensive time-domain simulation which is used to check the transient security and stability constraints. Sometimes, it is needed to take tens of seconds to perform the time-domain simulation evaluation on a single scheme, especially for a large power system. Therefore, the large population scale will cause the evolutionary emergency load shedding optimization to be extremely time-consuming, and there is a contradiction between improving the global convergence and improving the optimization speed.

In recent years, a data-driven technology is widely researched in dynamic security assessment of the power system. The dynamic security assessment can realize high efficiency by using a data-driven surrogate model to replace time-consuming time-domain simulation. The data-driven surrogate model is much faster than time-domain simulation evaluation because the data-driven surrogate model only needs limited algebraic operation and does not need complex numerical integration. Therefore, in the data-driven technology, the surrogate model is used for evaluating the emergency load-shedding candidate scheme, so that a potential method for improving the optimization efficiency of emergency load-shedding scheme is provided. The population scale can be increased by quick evaluation based on the surrogate model. The contradiction between the global convergence and the optimization speed can be solved. Therefore, various offline trained machine learning models can be embedded into an evolutionary solution framework to improve the convergence performance, for example, an online dynamic security control optimization framework based on a particle swarm optimization algorithm is provided in the prior art, and a radial basis function neural network is adopted as the surrogate model.

However, existing evolutionary algorithms have at least the following defects in solving the emergency load-shedding optimization problem:

(1) The population scale of the schemes in the evolutionary algorithms must be set large enough to ensure the global convergence. However, large-scale candidate schemes need to be evaluated by using time-consuming time-domain simulation. Heavy computational burden leads to the evolutionary algorithms being unable to be applied to the optimization of emergency load-shedding scheme online.

(2) Small population scale can improve the optimization speed of the evolutionary optimization algorithms. However, small population scale cannot ensure the diversity of candidate schemes, which leads to poor global convergence of the evolutionary algorithms, and the optimized load-shedding scheme is poor in quality, that is, poor in economy, and cannot be applied to the actual power system.

(3) At present, the integration of the data-driven surrogate model and evolutionary algorithms is to completely replace the time-domain simulation evaluation by the offline trained surrogate model. Therefore, the accuracy of surrogate model must be ensured to obtain good optimization scheme. However, the operation mode of the power system changes constantly, especially for the power systems with high penetration of fluctuating renewable energy. The accuracy of the offline trained surrogate model in all operation modes cannot be strictly guaranteed. If the surrogate model is updated online, many new training samples must be generated by time-domain simulation. The optimization speed of emergency load-shedding will be significantly reduced.

Therefore, completely replacing the time-domain simulation with the surrogate model in the emergency load-shedding optimization problem cannot be effectively applied to the actual operation scenario of the power system.

### SUMMARY

In order to solve the above problems, the present disclosure provides a method and system for optimizing power grid emergency load-shedding based on proliferation and reduction evolution, which can effectively solve a contradiction between global convergence and optimization speed of evolutionary algorithms, and realizes online optimization of an emergency load-shedding scheme.

In some implementations, the following technical solutions are used:
A method for optimizing power grid emergency load-shedding based on proliferation and reduction evolution includes:
obtaining upper and lower limits data of allowed load-shedding amount of each load-shedding station and boundary threshold data of transient security and stability constraint indexes in a power grid; and obtaining an optimal power grid emergency load-shedding scheme based on these data and an evolutionary optimization method, where a working process of the evolutionary optimization method includes:
initializing optimization model parameters and a parent population, evaluating each emergency load-shedding scheme in the parent population by time-domain simulation, and initially training a surrogate model; and
generating a plurality of temporary candidate schemes according to a proliferation strategy, and evaluating all the temporary candidate schemes by the surrogate model; pre-screening a set number of the temporary candidate schemes as offspring schemes according to evaluation results; validating the offspring schemes by time-domain simulation, comparing simulation results of the offspring schemes with simulation results of the parent schemes, and selecting a set number of the optimal schemes to form a next-generation parent population; if iteration is terminated, outputting the optimal power grid emergency load-shedding scheme; and otherwise, updating the surrogate model and returning to a proliferation process.

In some other implementations, the following technical solutions are used:
A system for optimizing power grid emergency load-shedding based on proliferation and reduction evolution includes:
a data obtaining module configured to obtain upper and lower limits of allowed load-shedding amount of each load-shedding station and boundary threshold data of transient security and stability constraint indexes of a power grid; and a power grid emergency load-shedding module configured to obtain an optimal power grid emergency load-shedding scheme based on the data and an evolutionary optimization method, where a working process of the evolutionary optimization method includes:
initializing model parameters and a parent population, evaluating each emergency load-shedding scheme in the parent population by time-domain simulation, and initially-training a surrogate model; and
generating a plurality of temporary candidate schemes according to a proliferation strategy, and evaluating all the temporary candidate schemes by the surrogate model; pre-screening a set number of the temporary candidate schemes as offspring schemes according to evaluation results; validating the offspring schemes by time-domain simulation, comparing simulation results of the offspring schemes with simulation results of the parent schemes, and selecting a set number of the optimal schemes to form a next-generation parent population; if iteration is terminated, outputting the optimal power grid emergency load-shedding scheme; and otherwise, updating the surrogate model and returning to a proliferation process.

In some other implementations, the following technical solutions are used:

A terminal device includes a processor and a memory, where the processor is configured to implement each instruction; the memory is configured to store a plurality of instructions; and the instructions are suitable for being loaded by the processor and executing the above method for optimizing power grid emergency load-shedding based on proliferation and reduction evolution.

Compared with the prior art, the present disclosure has the following beneficial effects.

(1) The proliferation strategy is provided in the present disclosure, and a large number of temporary candidate schemes are generated on the basis of a parent emergency load-shedding scheme. In the proliferation process, the schemes are divided into three groups of a superior scheme, a normal scheme and an inferior scheme based on distribution characteristics of different schemes in an optimization area, and different evolution search operators are adopted for the schemes of different groups to improve the search efficiency and the diversity of temporary populations. Due to the existence of the temporary populations, the possibility, of finding out the global optimal point in each iteration process is improved, and therefore the proliferation strategy is beneficial for improving the global convergence of the evolutionary algorithms under the condition that the population scale is not large.

(2) The reduction strategy provided by the present disclosure includes two key processes, namely pre-screening based on the surrogate model and validation based on time-domain simulation. In the pre-screening process based on the surrogate model, the machine learning model is used as the surrogate model to evaluate a large number of temporary candidate schemes. The calculation of the surrogate model only involves algebraic operation, the calculation efficiency is high, and security and stability indexes under different schemes can be quickly calculated. According to the evaluation results with the surrogate model, an optimal candidate scheme is pre-screened to serve as the offspring scheme; and in the validation process based on time-domain simulation, the offspring scheme is accurately, evaluated by time-domain simulation. The evaluated offspring scheme is compared with the parent scheme to generate a next-generation parent scheme. Meanwhile, the evaluation results of the offspring schemes is stored in a training sample database and is used for updating the surrogate model of the next generation, Therefore, the mentioned reduction strategy provided can ensure the optimization efficiency and the accuracy of the optimization result on the premise of not increasing the time-domain simulation frequency in each iteration process.

(3) An evolutionary optimization framework capable of quickly optimizing the emergency load-shedding scheme is designed according to the mentioned proliferation and reduction evolution strategies provided by the present disclosure; and compared with a conventional evolutionary algorithm, the mentioned global convergence of an evolutionary optimization framework is better. Under a given power grid operation mode and a power deficiency disturbance accident, a global optimal scheme or a scheme close to global optimization can be quickly obtained. Compared with other evolutionary frameworks based on the surrogate model, a feasible optimization scheme can be accurately obtained through the mentioned evolutionary optimization framework, so that the adaptability to the power grid is improved and the scheme is more suitable for engineering in practice.

Other features and advantages of the additional aspects of the present disclosure will be provided in the following description, some of which will become apparent from the following description or may be learned from practices of the present disclosure.

### BRIEF DESCRIPTION OF THE DRAWINGS

FIG. 1 is a flow chart of emergency load-shedding evolutionary optimization under a proliferation and reduction evolution strategy framework in an embodiment of the present disclosure;

FIG. 2 is a schematic diagram of a proliferation strategy in an embodiment of the present disclosure;

FIG. 3 is a schematic diagram of a reduction strategy in an embodiment of the present disclosure; and

FIG. 4 is a comparison chart of an evolutionary algorithm with or without proliferation and reduction evolution strategies in an embodiment of the present disclosure.

### DETAILED DESCRIPTION

It should be noted that, the following detailed descriptions are exemplary, and are intended to provide a further description to this application. Unless otherwise specified, all technical and scientific terms used in the present disclosure have the same meaning as commonly understood by a person of ordinary skill in the art to which this application belongs.

It should be noted that terms used herein are only for the purpose of describing specific implementations and are not intended to limit the exemplary implementations of this application. As used herein, the singular form is intended to include the plural form, unless the context clearly indicates otherwise. In addition, it should further be understood that terms “comprise” and/or “include” used in this specification indicate that there are features, steps, operations, devices, components, and/or combinations thereof.

### Embodiment 1

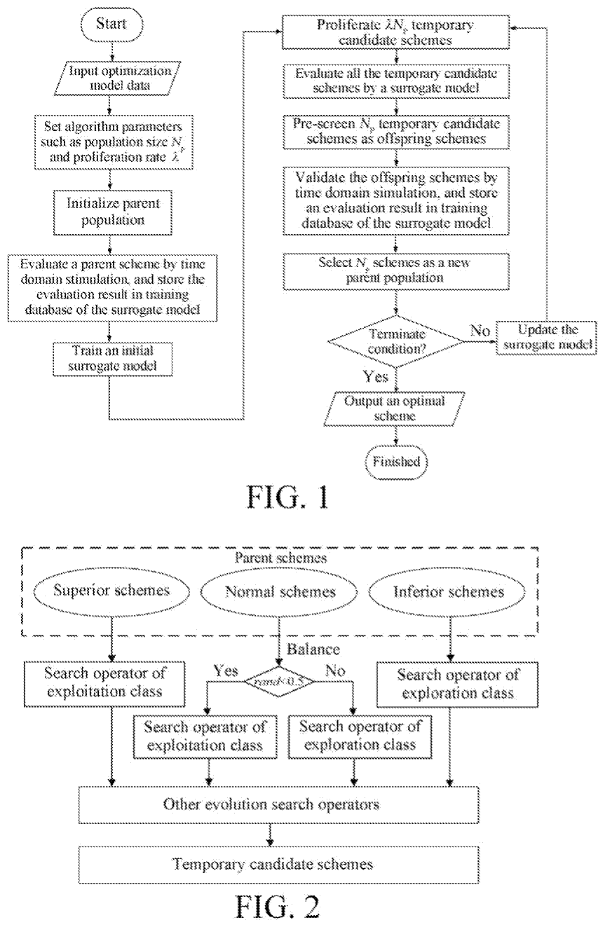

In one or more implementations, a method for optimizing power grid emergency load-shedding based on a proliferation and reduction evolution strategy framework is provided. As shown in FIG. 1, the method includes the following processes:

(1) Optimization model related data is input, such as upper and lower limits of allowed load-shedding amount of each load-shedding station and a boundary threshold of transient security and stability constraint indexes of a power grid; and evolutionary algorithm related parameters are set, such as population size Nₚ and proliferation rate λ.

(2) A parent population is initialized, and each emergency load-shedding scheme in the parent population is evaluated by time-domain simulation, namely the transient security and stability constraint indexes are checked, and an evaluation result is stored in a training database of a surrogate model.

In this embodiment, the process of initializing the parent population is as follows:

Nₚ initial parent schemes are generated in a search space the under upper and lower limits of allowed load-shedding amount of each load-shedding station by adopting a Latin cube sampling method; specifically, one vector represents one scheme, and each element in the vector represents the load-shedding amount or load-shedding rate of each load-shedding station.

In this embodiment, the process of evaluating the emergency load-shedding scheme by time-domain simulation is as follows:

transient security indexes of the power grid are obtained by time-domain simulation software after the system executes the emergency load-shedding scheme when suffering from a power deficiency accident. The transient security indexes at least include a transient power angle, transient voltage and a transient frequency security index.

(3) A surrogate model is initially trained by using data in the training database.

In this embodiment, a method for constructing the surrogate model is as follows:

a data-driven machine learning model is adopted as the surrogate model. A load-shedding vector under an emergency load-shedding scheme and the evaluated transient security and stability constraint indexes form a training sample. The load-shedding vector is used as an input characteristic, and the transient security and stability constraint indexes of the power grid are used as an output label. All parent schemes are used for training a multi-input multi-output surrogate model.

(4) Nₚλ temporary candidate schemes are generated according to a proliferation strategy, and evaluate all the temporary candidate schemes by the surrogate model.

Specifically, FIG. 2 is the schematic diagram of the proliferation strategy. As shown in FIG. 2, the parent schemes are divided into three groups based on superior-inferior properties according to feasibility criterion, namely, a superior scheme, a normal scheme and an inferior scheme. Firstly, a security constraint violation degree of each scheme is calculated, then a standardized security constraint violation degree of each scheme is calculated, and finally different schemes are compared according to the standardized security constraint violation degree.

The security constraint violation degree refers to a difference value between a security threshold of a certain security index and the security index, and the difference value range is limited from zero to positive infinity. The standardized security constraint violation degree is a standardized sum of all the security constraint violation degrees, so the standardized security constraint violation degree is a non-negative real number. The scheme with the standard constraint violation degree being zero is a feasible scheme, otherwise, the scheme is an infeasible scheme.

A feasibility criterion specifies a comparison method between different schemes as follows:

(1) In case of a feasible scheme and an infeasible scheme, the feasible scheme is superior, and the other scheme is inferior.

(2) In case of two feasible schemes, the scheme with a smaller load-shedding amount is superior, and the other scheme is inferior.

(3) In case of two infeasible schemes, the scheme with a small constraint violation degree is superior, and the other scheme is inferior.

The proportion of the three groups is dynamically changed along with the iteration of evolution; and schemes under different groups adopt proper evolution operators to meet the relative evolution requirements. The superior scheme adopts an evolution search operator of exploitation class to meet the requirement of developing a good optimization area around the superior scheme. The interior scheme adopts an evolution search operator of exploration class to meet the requirement of exploring a good optimization area outside the inferior scheme. The normal scheme can balance the exploitation and exploration requirements by randomly, adopting the evolution search operator of the exploitation class under the superior scheme and the evolution search operator of the exploration class under the inferior scheme.

Each scheme in the parent population is traversed, a corresponding search operator is executed on each scheme according to a result of superior-inferior grouping, and the search operator is circularly executed times on each scheme. In case of other evolution search operators in the evolutionary logic, the other evolution search operators are circularly executed λ times to obtain a final Nₚλ temporary candidate scheme. λ is referred to as a proliferation rate.

As an optional implementation, the constraint violation degree D of a constraint p in the feasibility criterion is defined as:

Dₚ(α_{k,g})=max{ξₚ−η_{p,k,g},0} (1),

where α_{k,g} is a k^{th} parent scheme of a g^{th} generation, kϵ{1, 2 . . . , Nₚ}; ξₚ is a security boundary threshold of the constraint p; and η_{p,k,g} is a security index numerical value of the constraint p under the scheme α_{k,g}.

As an optional implementation, a method for dynamically changing the proportion of the three groups along with the iteration of evolution is that:

the evaluation in early stage is required to focus on the exploration of schemes rather than exploitation. Therefore, the whole optimization search space can be fully searched, and the most promising optimization area with a global optimal point is found out. In the later stage of evolution, most parent schemes are positioned in a single or more promising optimization areas. These schemes are required to fully develop the areas nearby to improve the convergence quality and speed. According to the analysis above, the proportion of inferior schemes for exploration is required to be higher than that of superior schemes in the early, stage of evolution. In the later stage of evolution, the proportional relationship between the inferior schemes and the superior schemes is opposite to that in the early stage. Therefore, the proportion of the three schemes is set according to the formula (2). The sum of the proportion of the three schemes is kept at 1 from the early stage to the later stage.

$$\{ \begin{matrix}{r}_{SI} = {r}_{SI 0} + \frac{{r}_{II 0}}{{10}^{2}} \times {10}^{( 2 \times g / {g}_{max} )} & Superior scheme \\ {r}_{NI} = 1 - {r}_{SI} - {r}_{II} & Medium scheme \\ {r}_{II} = {r}_{II 0} - \frac{{r}_{II 0}}{{10}^{2}} \times {10}^{( 2 \times g / {g}_{max} )} & Inferior scheme\end{matrix} , \qquad ( 2 )$$

where gₘₐₓ is the maximum number of iterations; r_{SI0} and r_{II0} are initial proportions of the superior scheme and the interior scheme respectively; in the early stage of evolution, the value of r_{II0} is required to be greater than the value of r_{SI0} and is generally set to be greater than ⅓; and the proportion of the normal scheme is set to be a constant for exploration and exploitation.

As an optional implementation, the evolution search operator of exploitation class, the evolution search operator of exploration class and other evolution search operators are operators in the evolutionary algorithms. Corresponding search operators are designed for different evolutionary algorithms according to different evolution logics. A differential evolution algorithm is taken as an example, and the design of the above three types of evolution search operators is shown as follows.

Mutation operator of exploitation class (evolution search operator of exploitation class):

β_{k,g}=α_{k,g}+F×[(α_{r1,g}−α_{k,g})+(α_{r2,g}−α_{r3,g})] (3),

where β_{k,g}, is a mutation scheme of a parent scheme α_{k,g}; F is a mutation factor and is in a range of [1, Nₚ]; and r₁, r₂ and r₃ are three different random integers and are in the range of [1, Nₚ], and k≠r₁≠r₂≠r₃.

Mutation operator of exploration class (evolution search operator of exploration class):

β_{k,g}=α_{k,g}+F×[(α_{r4,g}−α_{k,g})+(α_{r5,g}−αᵣ₆^{A})] (4),

where α_{r4,g} is a random scheme in the previous best b % parent scheme; r₅ is a random integer and is in the range of [1, Nₚ]; αᵣ₆^{A} is a scheme randomly extracted from a current parent population and a memory bank A and meets α_{r4,g}≠α_{r5,g}≠αᵣ₆^{A}; A stores some inferior offspring schemes, namely the offspring schemes which do not enter the next generation. The storage modes of these offspring schemes are introduced in the reduction strategy.

For each parent scheme, the above operator is circularly executed. β_{k,g}^{m} represents an m^{th} variation scheme of a k^{th} parent scheme.

Crossover operator (other evolution search operators):

$${γ}_{k , i , g}^{m} = \{ \begin{matrix}{β}_{k , i , g}^{m} & if {rand}^{m} \leq CR or i = {i}_{rand}^{m} \\ {α}_{k , i , g} & otherwise\end{matrix} , \qquad ( 5 )$$

where γ_{k,g}^{m} is a temporary candidate scheme; rand^{m} is a random number and is distributed between [0, 1]; CRϵ[0, 1] is a crossover factor; and i_{rand}^{m} is an integer randomly selected in [1, N], and Nis the dimension of a vector.

(5) Nₚ temporary candidate schemes are pre-screened as offspring schemes according to evaluation results with surrogate model.

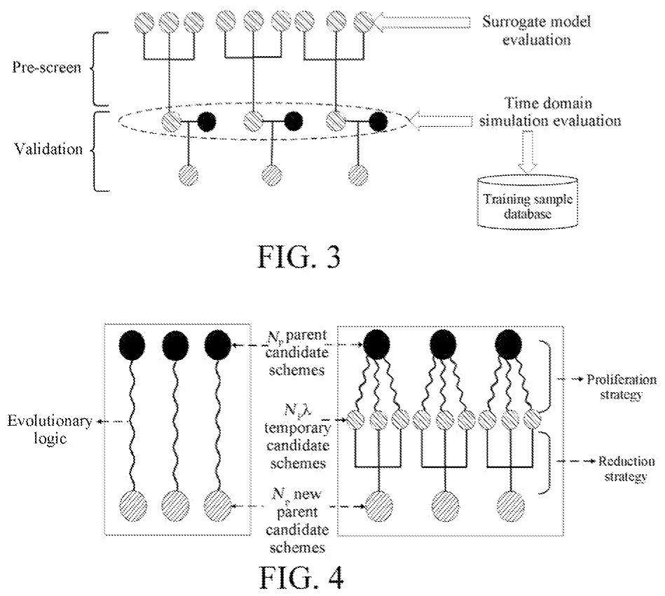

FIG. 3 is the schematic diagram of the reduction strategy. As shown in FIG. 3, the reduction strategy includes two key steps, that is, pre-screening based on the surrogate model and validation based on time-domain simulation.

In this embodiment, the process of pre-screening the offspring scheme based on the surrogate model is as follows:

all temporary candidate schemes are evaluated by using the constructed surrogate model. The feasibility of each temporary candidate scheme is judged according to the feasibility criterion. If a feasible scheme exists, the optimal feasible scheme is selected as the offspring scheme. If only an infeasible scheme exists, the optimal infeasible scheme is selected as the offspring scheme. If both feasible and infeasible schemes exist, an absolute constraint violation margin of the scheme is defined as |ξₚ−ηₚ| for a certain specific constraint p, and ξₚ is the security boundary threshold of the constraint p; ηₚ is the security index value of the constraint p. Whether the following three conditions are simultaneously satisfied is judged:

(1) Only one constraint is violated in the optimal infeasible scheme.

(2) The absolute constraint violation margin violated by the optimal infeasible scheme under the constraint p is less than the absolute constraint violation margin of the optimal feasible scheme under the corresponding constraint.

(3) The load-shedding amount of the optimal infeasible scheme is less than that of the optimal feasible scheme.

If the three conditions above are met, the optimal infeasible scheme is selected as the offspring scheme at a certain probability, otherwise, the optimal feasible scheme is selected as the offspring scheme.

The above pre-screening process is to screen one offspring scheme from λ temporary candidate schemes generated from one parent scheme. The above process is circularly executed Nₚ times to complete the pre-screening of all temporary candidate schemes, and finally Nₚ offspring schemes are reserved.

(6) The offspring scheme is validated by time-domain simulation, and the evaluation result is stored in a training database of the surrogate model. Compare the offspring scheme with the parent scheme according to a time-domain simulation result, and select Nₚ optimal schemes to form a next-generation parent population Store part of eliminated schemes to provide scheme diversity for the next proliferation.

In this embodiment, the process for validating based on time-domain simulation is as follows:

Firstly, the pre-screened offspring schemes are validated by time-domain simulation to obtain real security constraint indexes. The evaluation result is stored in the training database of the surrogate model for updating a surrogate model of the next generation.

Then, the validated offspring schemes are compared with the corresponding parent schemes, that is, the k^{th} offspring scheme is compared with the k^{th} parent scheme (0<k≤Nₚ). The superior-inferior properties of the two schemes are judged according to the feasibility criterion, the superior scheme is reserved to enter the next generation, and the inferior scheme is eliminated.

Whether the eliminated offspring scheme simultaneously meets the following conditions is further judged:

(1) The eliminated scheme is the feasible scheme.

(2) The eliminated scheme is the infeasible scheme and only violates one constraint, and meanwhile, the parent scheme is the feasible scheme. The absolute constraint violation margin violated by the eliminated infeasible scheme under the constraint is smaller than the absolute constraint violation margin of the parent scheme under the corresponding constraint, and the load-shedding amount is smaller than that of the parent scheme.

If the conditions are met, the eliminated offspring scheme is stored in the memory bank A, and otherwise the scheme is not stored. Individuals in the memory bank A are used for improving the diversity of the schemes in the proliferation process.

(7) It is judged whether termination conditions are met or not, if yes, the optimal scheme is output as an optimization result, otherwise, the surrogate model is updated by data in the training database of the surrogate model and returned to the proliferation step, and the steps are continued to execute in sequence until the termination conditions are met.

The key of the technology above lies in the proliferation and reduction evolution strategies, and the reduction strategy includes two key steps, namely pre-screening based on the surrogate model and validation based on time-domain simulation.

FIG. 4 is a comparison chart of an evolutionary algorithm with or without the proliferation and reduction evolution strategies; and as shown in FIG. 4, a structure graph in a left square frame in FIG. 4 is an iteration structure of the evolutionary algorithm without the proliferation and reduction strategies. In each generation, the parent scheme subjected to time-domain simulation evaluation directly generates a new parent scheme according to the evolution logic. The new parent scheme is also evaluated by time-domain simulation. It is assumed that the size of a population scale is Nₚ, and Nₚ schemes need to be evaluated by time-domain simulation in each iteration. The large Nₚ can improve the population diversity and the global convergence of the evolutionary algorithm. However, the large Np will cause heavy calculation burden, resulting in failure of online application. The calculation burden is derived from the increase of the time-consuming time-domain simulation evaluation frequency. The small Nₚ will cause poor global convergence of the evolutionary algorithm and cannot hinder practical application. Therefore, in the evolutionary structure without the proliferation and reduction strategies, the global convergence and the optimization speed are opposite to each other.

A structure in a right square frame in FIG. 4 is an iteration structure of the evolutionary algorithm with the proliferation and reduction strategies. In each generation, each parent scheme generates temporary candidate schemes according to the proliferation strategy. A large number of temporary candidate schemes can effectively improve the population diversity and the global convergence of the evolutionary algorithm. Then, in the reduction strategy, the machine learning model is used as the surrogate model to evaluate Nₚλ temporary candidate schemes so as to improve the evaluation efficiency. According to the evaluation result, Nₚ schemes are selected Nₚλ temporary candidate schemes as the new parent candidate schemes. The new parent schemes are evaluated by time-domain simulation. Therefore, in the evolutionary structure with the proliferation and reduction evolutionary strategies, the population diversity of each generation can be effectively improved without increasing time-domain simulation evaluation frequency of each generation. The proliferation and reduction evolutionary strategies effectively solve the contradiction between global convergence and optimization speed when the evolutionary algorithm is applied to the emergency load-shedding optimization problem.

### Embodiment 2

In one or more implementations, a system for optimizing power grid emergency load-shedding based on a proliferation and reduction evolution strategy framework is provided and includes:
a data obtaining module configured to obtain upper and lower limits of allowed load-shedding amount of each load-shedding station and boundary threshold data of transient security and stability constraint indexes of a power grid; and
a power grid emergency load-shedding module configured to obtain an optimal power grid emergency load-shedding scheme based on the data and an evolutionary optimization method. A working process of the evolutionary optimization method includes:

Model parameters and a parent population are initialized, each emergency load-shedding scheme in the parent population is evaluated by time-domain simulation, and a surrogate model is initially trained.

A plurality of temporary candidate schemes are generated according to a proliferation strategy, and all the temporary candidate schemes are evaluated by the surrogate model. A set number of the temporary candidate schemes are pre-screened as offspring schemes according to evaluation results. The offspring schemes are validated by time-domain simulation, simulation results of the offspring schemes are compared with simulation results of the parent schemes, and a set number of the optimal schemes are selected to form a next-generation parent population. If iteration is terminated, the optimal power grid emergency load-shedding scheme is output; and otherwise, the surrogate model is updated and returned to a proliferation process.

It is to be noted that the specific implementation methods of the above modules are described in detail in Embodiment 1, and will not be detailed herein.

### Embodiment 3

In one or more implementations, a terminal device is disclosed and includes a server, where the server includes a memory, a processor and a computer program which is stored in the memory and can be operated in the processor; and when the processor executes the program, the method for optimizing the power grid emergency load-shedding under the proliferation and reduction evolution strategy framework in the Embodiment 1 is realized. For brevity, no more description is made herein.

It is to be understood that in this embodiment, the processor can be a central processing unit (CPU), and the processor can also be other general processors, digital signal processors (DSPs), application specific integrated circuits (ASIC), field programmable gate arrays (FPGA) or other programmable logic apparatuses, discrete gates or transistor logic apparatuses, discrete hardware components, and the like. The general processors can be microprocessors or the processors can also be any conventional processors, and the like.

The memory can include a read-only memory and a random access memory and provides instructions and data to the processor; and a part of the memory can also include a nonvolatile random access memory. For example, the memory can also store device type information.

In the implementation process, the steps of the above method can be performed through an integrated logic circuit of hardware in the processor or instructions in a software form.

The specific implementations of the present disclosure are described above with reference to the accompanying drawings, but are not intended to limit the protection scope of the present disclosure. A person skilled in the art should understand that various modifications or deformations may be made without creative efforts based on the technical solutions of the present disclosure, and such modifications or deformations shall fall within the protection scope of the present disclosure.

1. A method for optimizing power grid emergency load-shedding based on proliferation and reduction evolution, comprising:
obtaining upper and lower limits of allowed load-shedding amount of each load-shedding station and boundary threshold data of transient security and stability constraint indexes of a power grid; and obtaining an optimal power grid emergency load-shedding scheme based on the upper and lower limits of allowed load-shedding amount of each load-shedding station and boundary threshold data of transient security and stability constraint indexes of the power grid and an evolutionary optimization method, wherein a working process of the evolutionary optimization method comprises:
initializing model parameters and a parent population, evaluating each emergency load-shedding scheme in the parent population by time-domain simulation, and initially training a surrogate model; and
generating a plurality of temporary candidate schemes according to a proliferation strategy, and evaluating all the temporary candidate schemes by the surrogate model; pre-screening a set number of the temporary candidate schemes as offspring schemes according to evaluation results; validating the offspring schemes by time-domain simulation, comparing simulation results of the offspring schemes with simulation results of the parent schemes, and selecting a set number of the optimal schemes to form a next-generation parent population; if iteration is terminated, outputting the optimal power grid emergency load-shedding scheme; and otherwise, updating the surrogate model and returning to a proliferation process;
the generating a plurality of temporary candidate schemes according to a proliferation strategy specifically comprises:
dividing the parent schemes by groups based on superior-inferior properties according to feasibility criterion, calculating a security constraint violation degree of each scheme, then calculating a standardized security constraint violation degree of each scheme, and finally comparing different schemes according to the standardized security constraint violation degrees; and
traversing each scheme in the parent population, executing a corresponding search operator on each scheme according to a result of superior-inferior grouping, and circularly executing the search operator λ times on each scheme; in case of other evolution search operators, circularly executing the other search operators λ times to obtain a final Nₚλ temporary candidate scheme; and Nₚ being size of a population, and λ being a proliferation rate.

2. The method for optimizing power grid emergency load-shedding based on proliferation and reduction evolution according to claim 1, wherein after evaluating each emergency load-shedding scheme in the parent population by time-domain simulation, and after validating the offspring schemes by time-domain simulation, the method further comprises: storing an evaluation result in a training database of a surrogate model.

3. The method for optimizing power grid emergency load-shedding based on proliferation and reduction evolution according to claim 1, wherein the initializing a parent population specifically comprises: setting population size as Nₚ, generating Nₚ initial parent schemes in a search space under upper and lower limits of allowed load-shedding amount of each load-shedding station by adopting a Latin cube sampling method; specifically, one vector representing one scheme, and each element in the vector representing the load-shedding amount or load-shedding rate of each load-shedding station.

4. The method for optimizing power grid emergency load-shedding based on proliferation and reduction evolution according to claim 1, wherein the evaluating each emergency load-shedding scheme in the parent population by time-domain simulation specifically comprises: simulating to obtain transient stability and security indexes of the power grid by time-domain simulation software after the system executes the emergency load-shedding scheme when suffering from a power deficiency accident, and the transient stability and security indexes at least comprise a transient power angle stability, transient voltage security and a transient frequency security index.

5. The method for optimizing power grid emergency load-shedding based on proliferation and reduction evolution according to claim 1, wherein the surrogate model is a data-driven machine learning model; a load-shedding vector under an emergency load-shedding scheme and the evaluated transient security and stability constraint indexes form a training sample; the load-shedding vector is used as an input characteristic, and the transient security and stability constraint indexes of the power grid are used as an output label; and all parent schemes are used for training a multi-input multi-output surrogate model.

6. The method for optimizing power grid emergency load-shedding based on proliferation and reduction evolution according to claim 1, wherein the evaluating all the temporary candidate schemes by the surrogate model specifically comprises:
judging the feasibility of each temporary candidate scheme according to the feasibility criterion:
if a feasible scheme exists, selecting the optimal feasible scheme as the offspring scheme;
if only an infeasible scheme exists, selecting the optimal infeasible scheme as the offspring scheme;
if both feasible and infeasible schemes exist, judging whether the following conditions are met:
(1) only one constraint is violated in the optimal infeasible scheme; (2) the absolute constraint violation degree of the optimal infeasible scheme is less than that of the optimal feasible scheme; and (3) the load-shedding amount of the optimal infeasible scheme is less than the optimal feasible scheme; and if the conditions are met, the optimal infeasible scheme is selected as the offspring scheme, otherwise, the optimal feasible scheme is selected as the offspring scheme.

7. The method for optimizing power grid emergency load-shedding based on proliferation and reduction evolution according to claim 1, wherein the validating the offspring schemes by time-domain simulation, comparing simulation results of the offspring schemes with simulation results of the parent schemes, and selecting a set number of the optimal schemes to form a next-generation parent population specifically comprises:
validating the offspring scheme by time-domain simulation to obtain real security constraint indexes; storing the evaluation result in the training database of the surrogate model for updating a surrogate model of the next generation;
comparing the validated offspring scheme with the corresponding parent scheme, determining superior-inferior properties of the two schemes according to the feasibility criterion, reserving the superior scheme to enter the next generation, and eliminating the inferior scheme; and meanwhile, selecting the eliminated offspring schemes meeting the set conditions for proliferation process.

8. A system for optimizing power grid emergency load-shedding based on proliferation and reduction evolution, comprising
a data obtaining module configured to obtain upper and lower limits of allowed load-shedding amount of each load-shedding station and boundary threshold data of transient security and stability constraint indexes of a power grid; and
a power grid emergency load-shedding module configured to obtain an optimal power grid emergency load-shedding scheme based on the upper and lower limits of allowed load-shedding amount of each load-shedding station and boundary threshold data of transient security and stability constraint indexes of the power grid and an evolutionary optimization method, wherein a working process of the evolutionary optimization method comprises:
initializing model parameters and a parent population, evaluating each emergency load-shedding scheme in the parent population by time-domain simulation, and initially training a surrogate model; and
generating a plurality of temporary candidate schemes according to a proliferation strategy, and evaluating all the temporary candidate schemes by the surrogate model; pre-screening a set number of the temporary candidate schemes as offspring schemes according to evaluation results; validating the offspring schemes by time-domain simulation, comparing simulation results of the offspring schemes with simulation results of the parent schemes, and selecting a set number of the optimal schemes to form a next-generation parent population; if iteration is terminated, outputting the optimal power grid emergency load-shedding scheme; and otherwise, updating the surrogate model and returning to a proliferation process.

9. A terminal device, comprising a processor and a memory, wherein the processor is configured to implement each instruction; the memory is configured to store a plurality of instructions; and the instructions are suitable for being loaded by the processor and executing the method for optimizing power grid emergency load-shedding based on proliferation and reduction evolution according to claim 1.
